(19) United States
(12) Patent Application Publication
(10) Pub. No.: US 2014/0251105 A1
(43) Pub. Date: Sep. 11, 2014

(54) Power Tool With Ferrous Contaminant Detection

(71) Applicant: Robert Bosch Tool Corporation, Broadview, IL (US)

(72) Inventor: Edward J. Vinarcik, West Lafayette, IN (US)

(73) Assignee: Robert Bosch Tool Corporation, Broadview, IL (US)

(21) Appl. No.: 14/204,871

(22) Filed: Mar. 11, 2014

Related U.S. Application Data
(60) Provisional application No. 61/776,571, filed on Mar. 11, 2013.

(51) Int. Cl. B23D 59/00

(52) U.S. Cl. CPC B23D 59/001
USPC 83/471

(57) ABSTRACT

A power tool comprises a base defining a work surface for supporting a workpiece and a tool assembly supported on the base and having a working tool configured to perform an operation on the workpiece when it is supported on the work surface. A sensor is supported by the base in proximity to the work surface that is configured to detect a ferrous contaminant in the workpiece when the workpiece is supported on the work surface for operation by the tool assembly. The sensor provides a signal to a user interface that is configured to generate an output sensible by the operator of the power tool when the sensor detects a contaminant.

### CROSS-REFERENCE TO RELATED APPLICATION

This application claims priority under 35 U.S.C. §119 to U.S. Provisional Application No. 61/776,571, filed on Mar. 11, 2013, the disclosure of which is incorporated herein by reference in its entirety.

### FIELD OF THE DISCLOSURE

The present disclosure relates to portable or bench top power tools, such as a miter saw, and particularly to a safety mechanism to prevent damage to the saw blade.

### BACKGROUND

In a typical power tool, the working tool is specifically adapted to the type of material being cut. For instance, in a woodworking miter saw the saw blade is configured to cut various grades and densities of wood. The saw blade material is chosen to efficiently perform the cut, endure the typical high rotational speeds of operation and have a suitable blade life before the saw teeth become too dull to use. As long as the saw blade only encounters the expected wood material the blade will perform well over its expected life. However, workpieces are often contaminated with a non-wood body, and particular a metallic body such as a staple, nail, wire and the like. When the rapidly rotating saw blade encounters the metallic contaminant the teeth of the blade can be irreparably damaged or in a worst case scenario striking the metallic contaminant can cause workpiece kick-back or otherwise dislodge the workpiece from the work surface of the power tool.

There is a need for a safety mechanism that can detect the presence of a metallic contaminant before the workpiece is engaged by the working tool.

### SUMMARY

A power tool is provided that comprises a base defining a work surface for supporting a workpiece and a tool assembly supported on the base and having a working tool configured to perform an operation on the workpiece when it is supported on the work surface. In one aspect of the present disclosure, a sensor is supported by the base in proximity to the work surface that is configured to detect a ferrous contaminant in the workpiece. The sensor is arranged relative to the work surface to detect the contaminant in the workpiece when the workpiece is supported on the work surface for operation by the tool assembly. The sensor is operable to generate a signal when a contaminant is detected and to provide that signal to a user interface that is configured to generate an output sensible by the operator of the power tool when the sensor detects a contaminant.

### DESCRIPTION OF THE FIGURES

FIG. 1 is a perspective view of a portable miter saw incorporating the ferrous contaminant detection feature described herein.

FIG. 2 is a side view of one embodiment of a sensor for detecting a contaminant in a workpiece.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

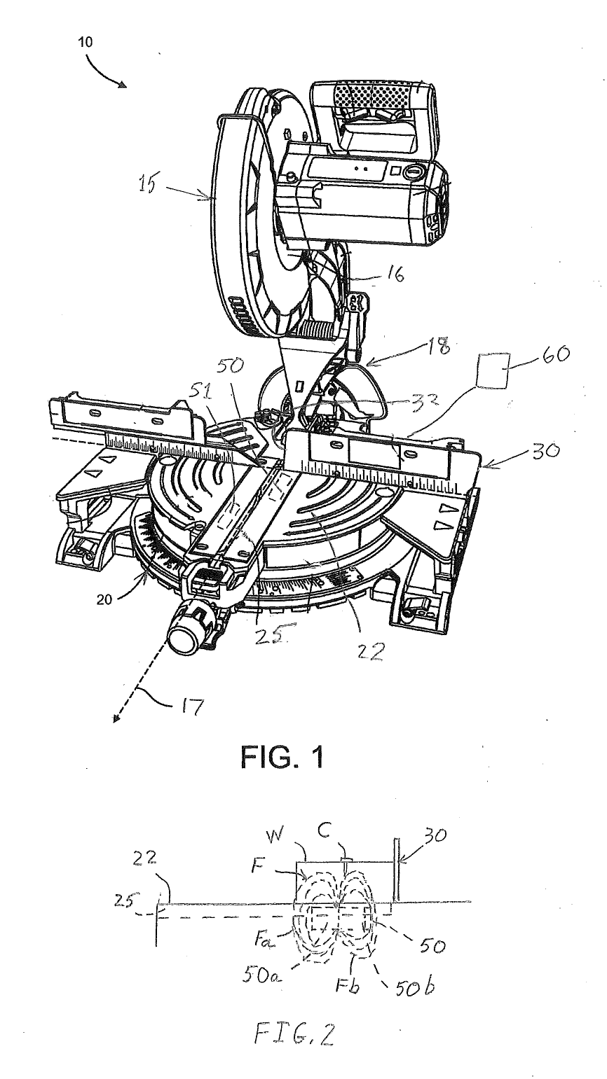

A portable power saw 10 is shown in FIG. 1 which, in accordance with the present disclosure, can be virtually any type of saw machine including bevel saw, compound saw, table saw, band saw, circular saw, vertical saw, planer, router, reciprocating saw, jig saw, or the like. For illustrative purposes the saw 10 is a miter saw that includes a saw assembly 15 supported on a base or platform assembly 20 by a pivoting mechanism 18, and including a working tool, namely the saw blade, configured to perform an operation on a workpiece. The base assembly defines a work surface 22 for supporting a workpiece. A slot 25 in the work surface is aligned with the cut line 17 of the saw blade 16 to provide clearance for the blade at the end of a cut. The base assembly 20 includes an adjustable fence assembly 30 that is mounted to the base assembly at an adjustable angle traversing the cut line 17 of the saw blade 16. The fence assembly 30 helps align the workpiece properly relative to the cut line 17 and saw blade 16 and provides a reaction surface for the workpiece during the cut.

According to the present disclosure, a number of sensors are integrated into the base assembly 20 to detect the presence of a ferrous contaminant in a workpiece to be cut by the miter saw 10. Thus, a sensor 50 may be disposed immediately adjacent the gap 32 in the fence assembly through which the saw assembly passes during the cut. In one embodiment, the sensor 50 is a magnetic sensor having a sensor field F that projects above the work surface 22 and that has a range sufficient to detect a ferrous contaminant C at the uppermost portion of a workpiece W, as depicted in FIG. 2. Thus, in one embodiment the sensor has a sensor range that is at least equal to the maximum height of a workpiece that can be operated on by the tool assembly 15. Alternatively, the sensor range can correspond to about half of the maximum workpiece height, with the understanding that the tool operator will turn the workpiece over on the work surface to sense both halves of the workpiece.

It can be appreciated that the base assembly 20 must be formed of a non-ferrous material to avoid detection by the sensor. It may also be necessary for the fence 30 to be formed of a non-ferrous material if the sensor is close enough to the fence for the field F to intersect the fence. As is typical with portable miter saws of the type shown in FIG. 1, the base and fence assemblies are formed of aluminum and/or a high strength plastic. The pivoting mechanism 18 may also be formed of aluminum, although a magnetic shield may be incorporated into the mechanism to prevent detection of ferrous components of the mechanism. The saw assembly may include a ferrous material, such as in the saw blade, but prior to execution of a cut the saw assembly is retracted from the base assembly 20 a sufficient distance to be out of range of the sensor 50.

The sensor 50 may be of the type used in magnetic locators, such as the Magna-Trak 102 locator sold by CST Corporation. The Magna-Trak 102 locator utilizes a pair of sensor coils, such as coils 50a and 50b, that each generate a corresponding magnetic field Fa and Fb, as illustrated in FIG. 2. In the presence of a ferrous contaminant the balance between the two magnetic fields is disrupted. The sensor 50 includes circuitry and/or a processor that energizes the coils, measures the relative disruption of the magnetic fields and generates a signal indicative of this disruption. In an alternative embodiment, the sensor 50 may employ one coil 50a to generate an alternating magnetic field Fa and use the other coil 50b to measure the generated magnetic field based on a current induced in that coil by the alternating magnetic field Fa. When the magnetic field Fa is disrupted by a ferrous contaminant C, eddy currents are induced in the contaminant which in turn produce a magnetic field associated with the contaminant. This induced field alters the magnetic field sensed by the second coil 50b (i.e., the current induced in that coil), thereby indicating the presence of the contaminant. In this alternative, the circuitry and/or processor associated with the sensor is configure to energize the first coil and sense the change in induced current in the second coil to generate an appropriate signal.

In one embodiment, the sensor 50 may be configured to simply detect the presence of a ferrous contaminant and to provide a signal to a user interface 60. The sensor can thus include circuitry and/or a microprocessor to evaluate signals from the sensor components (such as coils 50a, 50b) and to generate a signal(s) usable by the interface 60. The sensor may further include circuitry and/or a microprocessor configured to eliminate a false-positive, such as by comparing the sensor signal to a predetermined threshold value. The user interface 60 may include circuitry and/or a microprocessor configured to process the sensor signal(s) to generate a sensible output, such as an audible or a visual alert. In one embodiment, the user interface may include an indicator light, such as a red light, which is positioned at a location that is clearly visible to the tool operator so that the alert cannot be missed prior to activating the power tool. Alternatively, or in combination, the interface may generate an audible alarm signal, although the audible alarm must be loud enough to be heard when the saw assembly has been activated. In yet another alternative, the user interface 60 may include a processor that is integrates with the control circuitry for the power tool to prevent activation of the saw assembly and/or to cut power to the saw assembly, thereby preventing the cut from being made. This alternative may be less desirable because the operator may be aware of the ferrous contaminant and will deliberately avoid the contaminant during the cut.

The sensor 50 may be configured to generate a variable signal to help precisely locate the ferrous contaminant. For instance, a sensor such as the Magna-Trak 102 locator is configured to generate a signal that varies in intensity in relation to the proximity of the ferrous material to the pair of magnetic fields. Thus in one mode of operation of the contaminant detection system disclosed herein, the tool operator may position the workpiece on the sensor 50 prior to activating the saw assembly to determine if a contaminant is present. If the user interface 60 presents a “contaminant present” signal, the operator may move the workpiece across the sensor and evaluate the variable signal to locate the contaminant. In some embodiments, the sensor or user interface may be configured to provide a numerical read-out indicating the depth of the contaminant in the workpiece. The operator may then remove the contaminant or may simply mark the location of the contaminant so that the location can be avoided during the ensuing miter cut.

The power tool 10 may be provided with additional sensors, such as sensor 51, disposed at different locations on the base assembly 20 and/or fence assembly 30. Multiple sensors can be used to help locate the position of a ferrous contaminant in the workpiece or may provide a wider or tailored detection range.

The sensor(s) 50, 51 may be mounted to the base so that it is flush with or immediately adjacent the underside of the work surface 22. In order to provide the most useful indication of the location of the contaminant, the sensor(s) are preferably located immediately adjacent the slot 25, in the case of a power saw, or immediately adjacent the path of the working tool for other types of power tools. The user interface 60 may be mounted to the base assembly, saw assembly, handle, motor housing, or may be provided as a stand-alone component that is electrically connected to the sensor(s) 50, 51. The user interface may incorporate a processor that receives a signal from the sensor(s) and activates the sensible output. The processor may be an analog component such as a switch that is triggered by a signal generated by the sensor(s), the switch providing electrical power to the sensible output. Alternatively, the processor may be a more sophisticated microprocessor that receives and evaluates the signal generated by the sensor(s) to control the sensible output accordingly. The processor may be integrated into an existing processor of the power tool forming part of a safety system for the tool.

The present disclosure contemplates a power tool having a work surface for supporting a workpiece and for supporting a tool assembly, such as a miter saw assembly, in which a ferrous material sensor is associated with the work surface that is operable to detect the presence of a ferrous contaminant in the workpiece prior to being contacted by the tool assembly. It can be appreciated that although the illustrated embodiment is a power saw, other tools are contemplated for use with the workpiece contaminant sensor 50 disclosed herein. For instance, the tool may be a power drill rather than a saw.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A power tool comprising:
a base defining a work surface for supporting a workpiece;
a tool assembly supported on the base and having a working tool configured to perform an operation on the workpiece when it is supported on the work surface;
a sensor supported by the base and configured to detect a ferrous contaminant in the workpiece, the sensor arranged relative to the work surface to detect the contaminant in the workpiece when the workpiece is supported on the work surface for operation by the tool assembly; and
a user interface configured to generate an output sensible by the operator of the power tool when the sensor detects a contaminant.

2. The power tool of claim 1, wherein the sensor is supported at or immediately adjacent the work surface.

3. The power tool of claim 1, wherein:
the tool assembly is configured to move the working tool on a working path when performing the operation on the workpiece; and
the sensor is supported immediately adjacent the working path.

4. The power tool of claim 2, wherein:
the tool assembly is a power saw and the working tool is a saw blade;
the base defines a slot in the working surface in the working path to provide clearance for the saw blade; and
the sensor is positioned immediately adjacent said slot.

5. The power tool of claim 1, wherein:
the tool assembly is a power saw and includes a fence assembly associated with the work surface to position the workpiece for operation by the tool assembly; and
the sensor is supported on the base adjacent said fence assembly.

6. The power tool of claim 5, wherein:
the sensor is configured to have a sensing range in which the sensor can detect a ferrous contaminant; and
the work surface and the fence assembly are formed of a non-ferro-magnetic material at least within the sensing range of the sensor.

7. The power tool of claim 1, wherein:
the sensor is configured to have a sensing range in which the sensor can detect a ferrous contaminant; and
the work surface is formed of a non-ferro-magnetic material at least within the sensing range of the sensor.

8. The power tool of claim 1, wherein the user interface is configured to generate a visible and/or audible output that is sensible by the operator of the power tool.

9. The power tool of claim 1, wherein:
the tool assembly includes circuitry for providing power to the tool; and
the user interface is configured to interrupt power to the tool when a contaminant is detected by the sensor.

10. The power tool of claim 1, wherein the sensor is configured to have a sensing range in which the sensor can detect a ferrous contaminant, the sensing range corresponding to the maximum height of a workpiece that can be operated on by the tool assembly.
